(19) United States
(12) Patent Application Publication
(10) Pub. No.: US 2007/0113014 A1
(43) Pub. Date: May 17, 2007

(54) Weak referenced based eviction of persistent data from cache

(76) Inventors: Svetoslav Manolov, Sofia (BG); Ivo V. Simeonov, Sofia (BG)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/837,222

(22) Filed: Apr. 30, 2004

(51) Int. Cl. G06F 12/00

(52) U.S. Cl. 711/133

(57) ABSTRACT

A method is described in which a reference to an item of persistent data is established because the item of persistent data is cached. The reference is maintained whether or not the item of persistent data is used by an application. The reference is maintained whether or not the item of persistent data is referred to by another reference, where, the another reference is to implement a relational database relationship. The method includes removing the item of persistent data from the cache because the item of persistent data was only referred to by the reference.

### FIELD OF INVENTION

The field of invention relates generally to relational database management; and, more specifically, to weak referenced based eviction of persistent data from cache.

### BACKGROUND

Relational databases are used to define relationships between items of persistent data. For example, FIG. 1a shows a simplistic arrangement of relationships defined within a relational database. Here, an object oriented environment is assumed where first, second, third and fourth objects are used to represent “Customer A”, “Customer B”, “Order 1” and “Order 2”, respectively.

The relational database entries of FIG. 1a can be used, for example, to keep a record of the items purchased for specific customers. Specifically, specific items purchased by Customer A are listed in the “Order 1” object; and, specific items purchased by Customer B are listed in the “Order 2” object. Here, the Customer A object “represents” Customer A and can be assumed to keep various items that identify Customer A (e.g., name, address, phone number, etc.); and, the Customer B object “represents” Customer B and can be assumed to keep various items that identify Customer B (e.g., name, address, phone number, etc.).

Notions of “navigability” come into play in the design of a relational database. Navigability defines the ordered flow in which elements of data within a relational database can be accessed. For example, according to the simplistic relational database entries observed in FIG. 1a, purchased items listed in of “Order 1” can be retrieved with the identity of “Customer A” (and purchased items listed in of “Order 2” can be retrieved with the identity of “Customer B”)—but—the identity of “Customer A” can not be retrieved from the records of “Order 1” (and the identity of “Customer B” can not be retrieved from the records of “Order 2”).

Unidirectional relationships 101, 102 enforce the above policy in which information can be obtained in a first direction of object access flow but not in a second. In a typical application, the Customer A object would include information that defines the unidirectional relationship 101 to Order 1 but the Order 1 object would not include any such information (i.e., only the Customer A object has information that corresponds to relationship 101); and, the Customer B object would include information that defines the unidirectional relationship 101 to Order 2 but the Order 2 object would not include any such information (i.e., only the Customer B object has information that corresponds to relationship 102).

An artifact of the information that defines a relationship is a “reference”. In an object oriented environment, a reference is information that allows a “pointed to” object to be identified from a “source” object. Thus, an artifact of the information that defines relationship 101 would be a reference that allows the Order 1 object to be identified from the source Customer A object. One embodiment of a reference is the identification of a location in memory where the pointed to object is found. The source object includes or calls upon the reference in order to find the pointed to object. References can frequently be viewed as basic features having other uses beyond relational databases (such as a function call where a source object employs a reference to use a method contained by the pointed to object).

### SUMMARY

A method is described in which a reference to an item of persistent data is established because the item of persistent data is cached. The reference is maintained whether or not the item of persistent data is used by an application. The reference is maintained whether or not the item of persistent data is referred to by another reference, where, the another reference is to implement a relational database relationship. The method includes removing the item of persistent data from the cache because the item of persistent data was only referred to by the reference.

### FIGURES

The present invention is illustrated by way of example and not limitation in the figures of the accompanying drawings, in which like references indicate similar elements and in which:

FIG. 1 shows a depiction of a relational database;

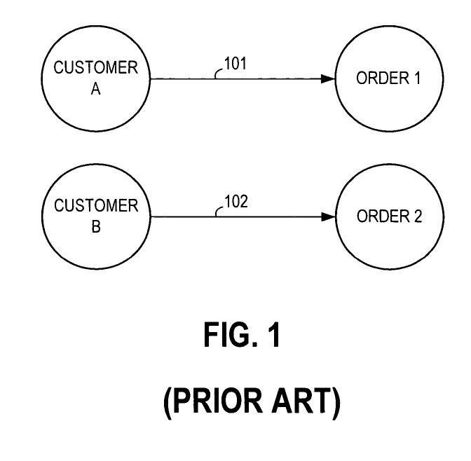

FIG. 2 shows a server having a persistent data management service;

FIG. 3a shows a collection of cached objects of persistent data that are associated through relational database relationships and that are weakly referred to by a cache object;

FIG. 3b shows an unused cached object of persistent data that is only weakly referred to by the cache object;

FIG. 4 shows a methodology for evicting cached objects of persistent data from cache;

FIGS. 5a through 5d shows a process by which a collection of cached objects that are associated through relational database relationships are evicted from the cache as a consequence of their not being used;

FIG. 6 shows a technique for modulating the policy used for evicting objects from cache as a function of the cache's population; and,

FIG. 7 shows an embodiment of a computing system.

### DETAILED DESCRIPTION

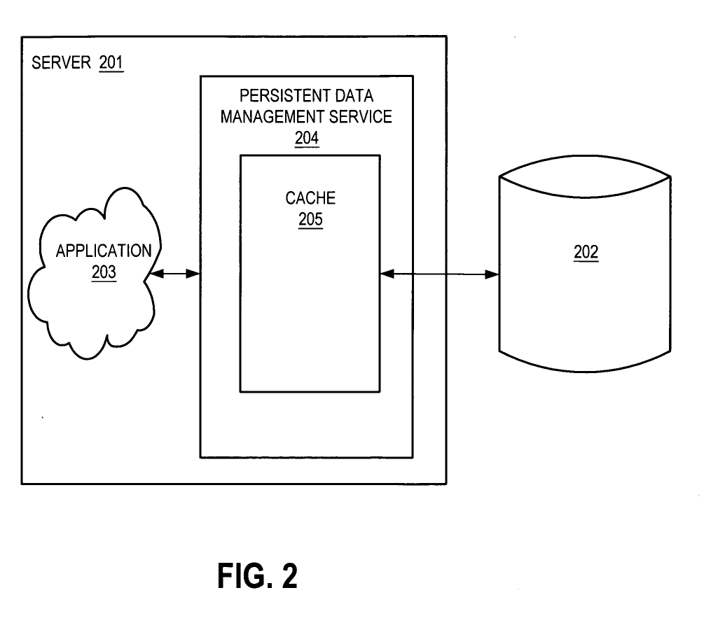

FIG. 2 shows, within a server 201, application software 203 accessing cached data entries through a persistent data management service 204. The persistent data management service 204 is configured to communicate to a database 202 (e.g., through a database connection service which is not shown in FIG. 2 for illustrative convenience). Server 201 may be a Java 2 Enterprise Edition (“J2EE”) server node which supports Enterprise Java Bean (“EJB”) components and EJB containers (at the business layer) and Servlets and Java Server Pages (“JSP”) (at the presentation layer). Other embodiments may be implemented in the context of various different software platforms including, by way of example, Microsoft .NET, Windows/NT, Microsoft Transaction Server (MTS), the Advanced Business Application Programming (“ABAP”) platforms developed by SAP AG and comparable platforms.

A persistent data management service 204 can be viewed, at least in one instance, as a “faster” database because it utilizes storage elements (e.g., semiconductor memory) that are integrated closer to the processors that execute the application software than the actual database 202 itself. These proximate storage elements are generally referred to as a cache 205. Here, the application 203 uses the persistent data management service 204 largely as it would an external database (e.g., requesting database entries and updating database entries).

The persistent database management service 204 manages cached database entries and communicates with the external database 202 to read/write database entries from database 202 from/to cache 205. Because the function of the persistent data management service 204 is heavily involved with cached information, for illustrative convenience, cache 205 is drawn as being part of the persistent data management service 204 itself.

An issue with the persistent data management service's use of the cache 205 is the presence in the cache of database entries that are no longer being used (or at least have not been used for some time and/or are not expected to be used for some time). Because the cache 205 has limited storage resources, populating the cache with database entries that are not being used results in efficiency if those database entries that are being used cannot be entered into cache 205. As such, some mechanism must exist for “cleansing” the cache 205 of the unused database entries.

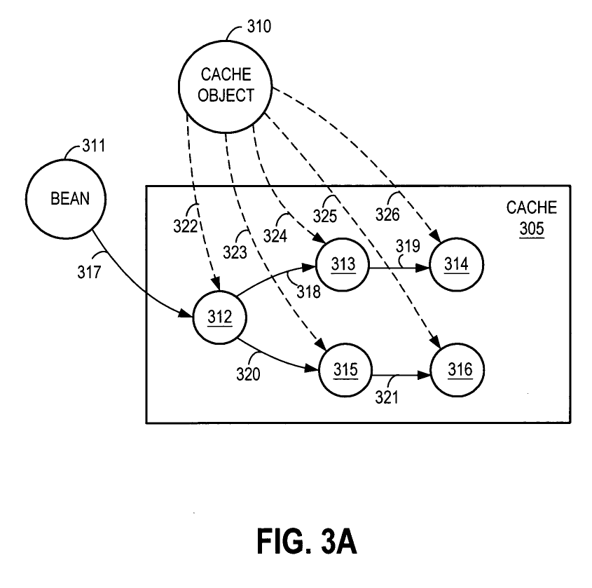

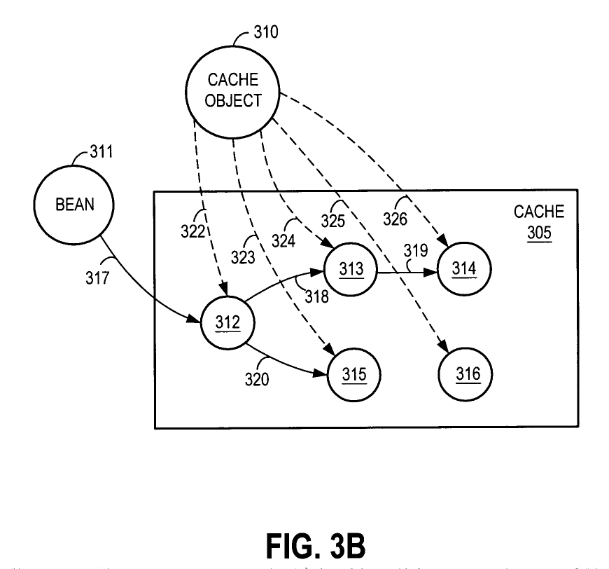

FIG. 3a relates to a method for cleaning out the cache of its unused database entries. FIG. 3a shows cached relational database entries 312 through 316 that are related through unidirectional relationships 318 through 321. A database entry is data that can be particularly requested from a database (e.g., one or more table rows, one or more table columns, a scalar table value, etc.). It is envisioned that in at least one implementation family, database entries correspond to entity beans in a Java based (e.g., J2EE) environment where entity beans are associated with one or more objects that represent a database entry that are operated upon with session beans within the confines of an Enterprise Java Beans (EJB) container.

As such, each the cached database entries 312 through 316 may be viewed as at least one object of an entity bean (or, more generally, as at least one object within an object oriented software environment). For simplicity, the discussion of FIG. 3a will treat each of items 310 through 316 as a single object that represents persistent data. According to the approach of FIG. 3a, a “cache” object 310 is used to represent the cache 305 itself. Having an object that represents the cache itself can be used for various cache related functions. For example, in an embodiment, the cache object 310 includes a hashing function that is able to correlate an identifier for a specific cached persistent data object (e.g., the cached object's primary key) to a reference to that cached object that identifies the cached object's location in the cache 305 (e.g., the cached object's memory address). Here, the cache object 310 is the source object of each such reference to each cached object of persistent data.

FIG. 3a shows these references schematically as “weak” reference 322, 323, 324, 325, 326 to cached persistent data objects 312, 315, 313, 316, 314, respectively. The term “weak” reference is to be contrasted against the term “strong” or “hard” reference. Here, the existence of a “weak” reference only signifies that a persistent data object exists in cache 305 while a “hard” reference signifies not only that a persistent data object exists in the cache 305 but also that it is being used from the cache 305 (e.g., by an application).

The distinction is pertinent because, as will be addressed more fully below, each persistent data object in cache 305 that is only referred to by a weak reference (i.e., the object is not referred to by a hard reference) can be removed from the cache (because without a hard reference it is not being used); while, each persistent data object that is referred to by at least one hard reference should remain in the cache because it is being used. Thus, the weak vs. hard reference distinction can be used as a criteria for deciding whether or not to keep a persistent data object in the cache 305 or to remove it from the cache 305.

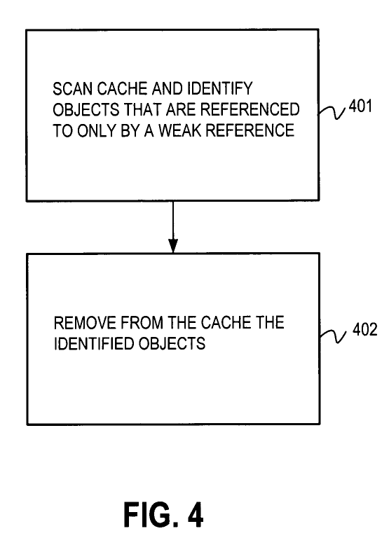

FIG. 4 displays a methodology for a “cache cleaning” method that operates according to this criteria. According to the methodology of FIG. 4, the cache is scanned and those persistent data objects that are referenced to only by a weak reference are identified 401. Each identified object is removed from the cache 402 so as to cleanse the cache of its objects of persistent data that are not presently being used. The removal of an item of persistent data from the cache 305 causes the item to be written into a database such as database 202 of FIG. 2.

In FIG. 3a the weak references 322, 323, 324, 325, 326 are drawn with dashed lines while the hard references are drawn with solid lines 317, 318, 319, 320, 321. According to the depiction of FIG. 3a, the relational database information associated with objects 312 through 316 are deemed to be in use because a reference 317 exists to object 312 from a source object that corresponds to a bean instance 311. In an embodiment, the bean instance object 311 corresponds to an entity bean that, when actually used (e.g., by a session bean—which on a larger scale can be deemed part of an application), becomes the source object for a reference 317 to persistent data object 312. Reference 317 is therefore deemed a hard reference because it arises from the actual use of the source object 311.

It will be appreciated by those of ordinary skill that a “bean” is a “component” within a Java Beans environment. Component based architectures are well-known in the art and are discussed in more detail at the end of this detailed description.

Because reference 317 is deemed a hard reference, persistent data object 312 would not be removed from the cache 305 if the methodology of FIG. 4 were executed (i.e., persistent data object 312 is not pointed to only by a weak reference). Likewise, because persistent data object 312 is not removed from the cache 305, none of references 318 through 321 will be torn down. Therefore, none of persistent data objects 313 through 316 will be removed from the cache (i.e., each of persistent data objects 313 through 316 are pointed to by hard references 318 through 321, respectively). Thus, the use of persistent data object 312 by bean instance 311 causes that portion of the cached relational database that may be invoked from persistent data object 312 to remain in cache 305.

FIG. 3b shows the same situation as in FIG. 3a, except that the relationship between objects 315 and 316 has been terminated. That is, for whatever reason, the cached portion of the relational database observed in FIG. 3a has been modified such that there no longer exists a unidirectional relationship from persistent data object 315 to persistent data object 316. As such, hard reference 321 has been torn down. Because hard reference 321 has been torn down, persistent data object 316 is exposed as having only a weak reference 325 to it. Since bean instance 311 is still observed to be using persistent data object 312 (by way of reference 317), each of references 318, 319, 320 remain as hard references. Because persistent data object 316 is only pointed to by a weak reference 325; while, persistent data objects 312, 313, 314, 315 are pointed to hard references 317, 318, 319, 320, respectively, only persistent data object 316 will be removed from cache 305.

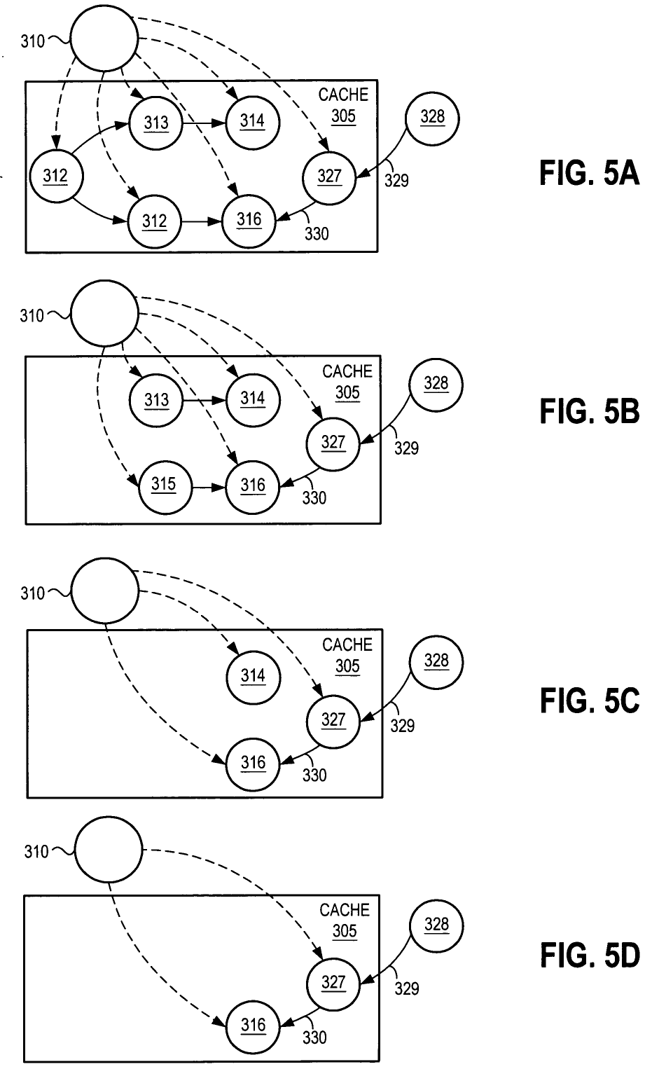

FIG. 5a shows the situation of FIG. 3a where: 1) another set of relational database relationships has been established that involves persistent data object 316 (specifically, new persistent data object 327 has been added which has a unidirectional relationship and corresponding reference 330 flowing to persistent data object 316); 2) the new set of relational database relationships is being used by bean instance object 328 (because a hard reference 329 exists from bean instance object 328 to persistent data object 327; and, 3) bean instance 311 of FIG. 3a is no longer using persistent data object 312 because hard reference 317 has been removed.

From FIG. 3a it is apparent that persistent data object 312 is exposed as having only a weak reference pointing to it. Therefore the methodology of FIG. 4 would remove persistent data object 312. Because persistent data object 312 is removed, so are the hard references that flowed from it to persistent data objects 313, 315. This leaves persistent data objects 313 and 315 exposed as being pointed to only by a weak reference. FIG. 5b shows this situation. From the situation of FIG. 5b it is clear that the methodology of FIG. 4 would remove persistent data objects 313 and 315.

Because persistent data objects 313 and 315 are removed, so are the hard references that flowed from them to persistent data objects 314 and 316, respectively. This leaves persistent data objects 314 exposed as being pointed to only by a weak reference. FIG. 5c shows this situation. Note that, because of the presence of hard reference 330, persistent data object 316 is not exposed as being pointed to only by a weak reference. From the situation of FIG. 5c it is clear that the methodology of FIG. 4 would remove persistent data object 314 but not persistent data object 316. FIG. 5d shows this situation. Comparing FIGS. 5a and 5d it is clear that the methodology of FIG. 4 systematically removes from cache those persistent data objects that are not being used.

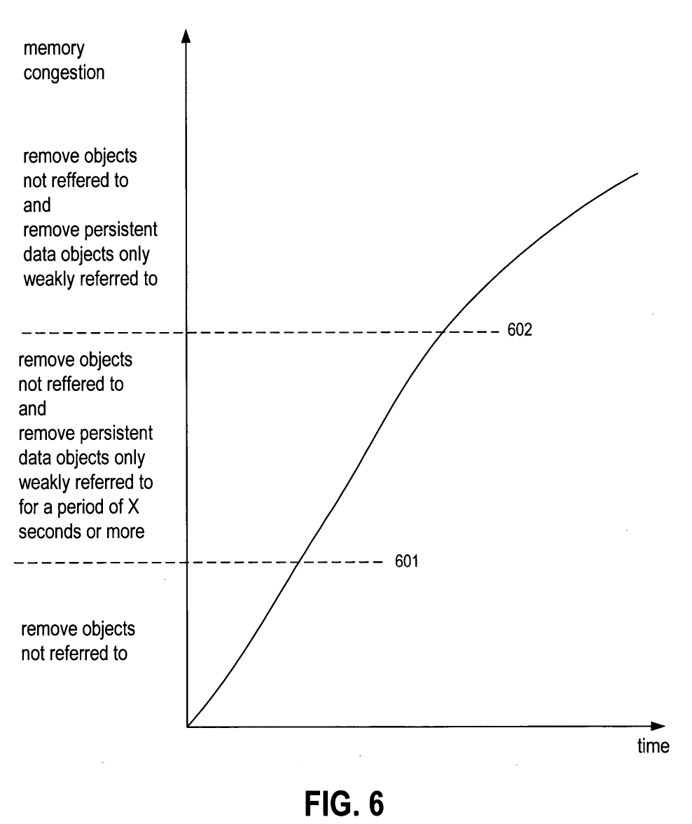

Before moving on to FIG. 6 it is important to recognize that bean instances 311, 328 as well as cache object 310 may reside in cache to. However, given that cache eviction was based on the existence of only a weak reference from cache object 310—and given that only persistent data objects are pointed to by weak references from cache object—only the persistent data objects are impacted by the methodology of FIG. 4. As such, bean instances 311, 328 and cache object 310 were not drawn as being within the cache 305 even though they could conceivably be stored in cache.

FIG. 6 elaborates on criteria for removing objects from cache. Specifically, FIG. 6 embraces the notion that items other than persistent data objects may be removed from cache and embraces the notion that the standard for removing objects from cache is lowered as the cache's population of objects increases. That is, as the cache becomes more congested, it is easier to remove an object from cache. As a simple model, FIG. 6 shows increasing cache congestion with time (e.g., the cache continually loads information at a greater rate than it evicts it).

Before the cache's congestion reaches level 601, only objects that are not referred to at all are removed from the cache. In an embodiment where all cached persistent data objects are at least weakly referred to (e.g., by a cache object) cached objects of persistent data are not removed from the cache when the cache's congestion is at level 601 or below. That is, objects representing persistent data are not evicted from the cache leaving only “other” objects that do not correspond to persistent data to be removed from the cache. This scheme puts some priority of persistent data over non persistent data when the cache is at comparatively low levels of congestion. Moreover, of the objects that are not referred to at all those that are not referred to are deemed lowest priority (e.g., because of the suggestion that they are not being used).

Once the cache's congestion reaches level 601, however, objects representing persistent data begin to be removed from the cache along with non referred to objects that do not correspond to persistent data. The persistent data objects that removed between levels 601 and 602 are only weakly referred to; and, must have remained only weakly referred to for some period of time (e.g., X seconds). This scheme essentially identifies persistent data objects that are not just “not being used” but are “not being used and have not been used for some period of time”. Thus the eviction scheme between levels 601 and 602 maintains priority of persistent data objects over “other” objects and also prioritizes unused persistent data objects that have a recent history of use over those that do not have a recent history of use.

Once the cache reaches level 602, however, the distinction between unused persistent data objects that have a recent history of use over those that do not have a recent history of use. That is, once level 602 is reached, if a persistent data object is only weakly referred to it is marked for removal irregardless of how long it has been only weakly referred to. Persistent data that is only weakly referred to is marked for removal along with “other” objects that do not correspond to persistent data beyond level 602.

It is important to re-emphasize that although the above discussion has been directed to examples within an object oriented environment, the teachings provided herein can be extended to non object oriented environments. For example, items of cached persistent data may strongly refer to one another or may be strongly referred to by modules of software that use them. Likewise, items of cached persistent data may be weakly referred to by a software module that represents the cache itself (or some other software module).

Component based software environments use granules of software (referred to as “components” or “component instances”) to perform basic functions. Some examples of component based architectures include Java Beans (JB), Enterprise Java Beans (EJB), Common Object Request Broker Architecture (CORBA), Component Object Model (COM), Distributed Component Object Model (DCOM) and derivatives there from.

The functional granularity offered by a plurality of different components provides a platform for developing a multitude of more comprehensive tasks. For example, a business application that graphically presents the results of calculations made to an individual's financial records (e.g., amortization of interest payments, growth in income, etc.) may be created by logically stringing together: 1) an instance of a first component that retrieves an individual's financial records from a database; 2) an instance of a second component that performs calculations upon financial records; and, 3) an instance of a third component that graphically presents financial information.

Moreover, within the same environment, another business application that only graphically presents an individual's existing financial records may be created by logically stringing together: 1) another instance of the first component mentioned just above; and, 2) another instance of the third component mentioned above. That is, different instances of the same component may be used to construct different applications. The number of components within a particular environment and the specific function(s) of each of the components within the environment are determined by the developers of the environment.

Components may also be created to represent separate instances of persistent data (e.g., a first component that represents a first row of database information, a second component that represents a second row of database information, etc.).

Processes taught by the discussion above may be performed with program code such as machine-executable instructions which cause a machine (such as a “virtual machine”, general-purpose processor or special-purpose processor) to perform certain functions. Alternatively, these functions may be performed by specific hardware components that contain hardwired logic for performing the functions, or by any combination of programmed computer components and custom hardware components.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

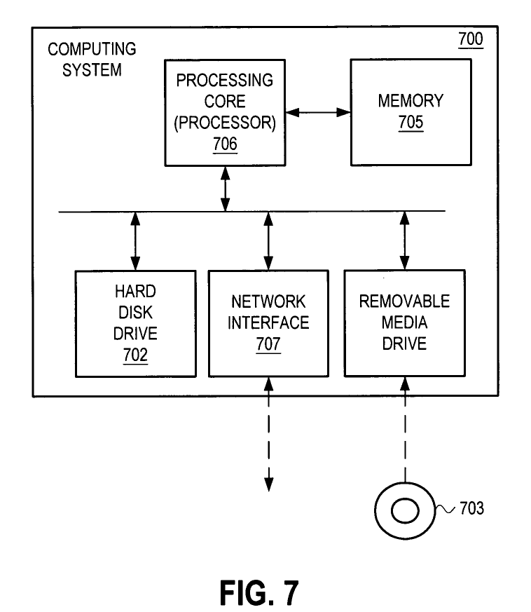

FIG. 7 is a block diagram of a computing system 700 that can execute program code stored by an article of manufacture. It is important to recognize that the computing system block diagram of FIG. 7 is just one of various computing system architectures. The applicable article of manufacture may include one or more fixed components (such as a hard disk drive 702 or memory 705) and/or various movable components such as a CD ROM 703, a compact disc, a magnetic tape, etc. In order to execute the program code, typically instructions of the program code are loaded into the Random Access Memory (RAM) 705; and, the processing core 706 then executes the instructions.

It is believed that processes taught by the discussion above can be practiced within various software environments such as, for example, object-oriented and non-object-oriented programming environments, Java based environments (such as a Java 2 Enterprise Edition (J2EE) environment or environments defined by other releases of the Java standard), or other environments (e.g., a .NET environment, a Windows/NT environment each provided by Microsoft Corporation).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1.-30. (canceled)

31. A method, comprising:
in an object-oriented environment, managing cached objects that represent cached instances of persisted data contained in a relational database table by performing the following:
caching in a cache a first object that contains a first item of persisted data, caching in said cache a second object that contains a second item of persisted data, instantiating a first weak reference to said first object and instantiating a second weak reference to said second object;
instantiating a hard uni-directional reference from said first object to said second object to establish a navigability relationship between said first object and said second object such that said second item of persisted data is retrievable from said first object but said first item of persisted data is not retrievable from said second object;
in response to an application's invocation of an object oriented entity component designed to enable said application's access to said first and second items of data from said cache, instantiating a hard reference from said object oriented entity component to said first object; and,
not removing said first object from said cache because of the existence of said hard reference and not removing said second object from said cache because of the existence of said hard unidirectional reference.

32. The method of claim 31 further comprising:
in response to said application's release of said object oriented entity component, removing said hard reference to said first object; and,
implementing the following memory congestion management algorithm:
1) if congestion of memory used to implement said cache is beneath a first level: not removing said first object from said cache even though said first object is referred to only by said first weak reference;
2) if congestion of said memory is above a second level: removing said first object from said cache as a consequence of said first object being referred to only by said first weak reference;
3) if congestion of said memory is between said first and second levels: removing said first object from said cache as a consequence of said first object having remained referred to only by said first weak reference for at least an established period of time.

33. The method of claim 32 wherein said managing is performed within a software container that contains Java beans and said object oriented entity component is an entity bean.

34. The method of claim 32 wherein said method further comprises:
after said first object has been removed from said cache, removing said hard unidirectional reference to said second object; and,
implementing the following memory congestion management algorithm:
1) if congestion of memory used to implement said cache is beneath a first level: not removing said second object from said cache even though said second object is referred to only by said second weak reference;
2) if congestion of said memory is above a second level: removing said second object from said cache as a consequence of said second object being referred to only by said second weak reference;
3) if congestion of said memory is between said first and second levels: removing said second object from said cache as a consequence of said second object having remained referred to only by said second weak reference for at least an established period of time.

35. The method of claim 34 wherein said managing is performed within a software container that contains Java beans and said object oriented entity component is an entity bean.

36. The method of claim 32 wherein said method further comprises:
after said first object has been removed from said cache, removing said hard unidirectional reference to said second object; and,
not removing said second object from said cache because of the existence of another hard reference to said second object.

37. The method of claim 36 wherein said managing is performed within a software container that contains Java beans and said object oriented entity component is an entity bean.

38. The method of claim 31 wherein said managing is performed within a software container that contains Java beans and said object oriented entity component is an entity bean.

39. A computing system comprising:
an interface to a relational database;
memory to implement a cache that stores persisted data in a table of said database including a first object that contains a first item of said persisted data and a second object that contains a second item of said persisted data;
a cache object to assist in accessing objects within said cache, a first weak reference from said cache object to said first object and a second weak reference from said cache object to said second object;
a hard unidirectional reference from said first object to said second object to establish a navigability relationship between said first object and said second object such that said second item of persisted data is retrievable from said first object but said first item of persisted data is not retrievable from said second object;
a hard reference to said first object from an object oriented entity component, said object oriented entity component to enable an application's access to said first and second items of data from said cache;
stored program code to implement a method on said computing system that when performed does not remove said first object from said cache because of the existence of said hard reference and that does not remove said second object from said cache because of the existence of said hard unidirectional reference.

40. The computing system of claim 39 further comprising second program code to perform a second method, comprising:
in response to said application's release of said object oriented entity component, removing said hard reference to said first object; and,
implementing the following memory congestion management algorithm:
1) if congestion of memory used to implement said cache is beneath a first level: not removing said first object from said cache even though said first object is referred to only by said first weak reference;
2) if congestion of said memory is above a second level: removing said first object from said cache as a consequence of said first object being referred to only by said first weak reference;
3) if congestion of said memory is between said first and second levels: removing said first object from said cache as a consequence of said first object having remained referred to only by said first weak reference for at least an established period of time.

41. The computing system of claim 40 comprising a software container that contains Java beans, said object oriented entity component being an entity bean.

42. The computing system of claim 40 wherein said method further comprises:
after said first object has been removed from said cache, removing said hard uni-directional reference to said second object; and,
implementing the following memory congestion management algorithm:
1) if congestion of memory used to implement said cache is beneath a first level: not removing said second object from said cache even though said second object is referred to only by said second weak reference;
2) if congestion of said memory is above a second level: removing said second object from said cache as a consequence of said second object being referred to only by said second weak reference;
3) if congestion of said memory is between said first and second levels: removing said second object from said cache as a consequence of said second object having remained referred to only by said second weak reference for at least an established period of time.

43. The computing system of claim 42 comprising a software container that contains Java beans, said object oriented entity component being an entity bean.

44. The computing system of claim 40 wherein said method further comprises:
after said first object has been removed from said cache, removing said hard uni-directional reference to said second object; and,
not removing said second object from said cache because of the existence of another hard reference to said second object.

45. The computing system of claim 44 comprising a software container that contains Java beans, said object oriented entity component being an entity bean.

46. The computing system of claim 39 comprising a software container that contains Java beans, said object oriented entity component being an entity bean.

47. An article of manufacture comprising program code that, when executed, cause a method to be performed, said method comprising:
in an object-oriented environment, managing cached objects that represent cached instances of persisted data contained in a relational database table by performing the following:
caching in a cache a first object that contains a first item of persisted data, caching in said cache a second object that contains a second item of persisted data, instantiating a first weak reference to said first object and instantiating a second weak reference to said second object;
instantiating a hard unidirectional reference from said first object to said second object to establish a navigability relationship between said first object and said second object such that said second item of persisted data is retrievable from said first object but said first item of persisted data is not retrievable from said second object;
in response to an application's invocation of an object oriented entity component designed to enable said application's access to said first and second items of data from said cache, instantiating a hard reference from said object oriented entity component to said first object; and,
not removing said first object from said cache because of the existence of said hard reference and not removing said second object from said cache because of the existence of said hard unidirectional reference.

48. The article of manufacture of claim 47 where said method further comprises:
in response to said application's release of said object oriented entity component, removing said hard reference to said first object; and,
implementing the following memory congestion management algorithm:
1) if congestion of memory used to implement said cache is beneath a first level: not removing said first object from said cache even though said first object is referred to only by said first weak reference;
2) if congestion of said memory is above a second level: removing said first object from said cache as a consequence of said first object being referred to only by said first weak reference;
3) if congestion of said memory is between said first and second levels: removing said first object from said cache as a consequence of said first object having remained referred to only by said first weak reference for at least an established period of time.

49. The article of manufacture of claim 48 wherein said method further comprises said managing being performed within a software container that contains Java beans and said object oriented entity component is an entity bean.

50. The article of manufacture of claim 48 wherein said method further comprises:
after said first object has been removed from said cache, removing said hard unidirectional reference to said second object; and,
implementing the following memory congestion management algorithm:
1) if congestion of memory used to implement said cache is beneath a first level: not removing said second object from said cache even though said second object is referred to only by said second weak reference;
2) if congestion of said memory is above a second level: removing said second object from said cache as a consequence of said second object being referred to only by said second weak reference;
3) if congestion of said memory is between said first and second levels: removing said second object from said cache as a consequence of said second object having remained referred to only by said second weak reference for at least an established period of time.

51. The article of manufacture of claim 50 wherein said method further comprises said managing being performed within a software container that contains Java beans and said object oriented entity component is an entity bean.

52. The article of manufacture of claim 48 wherein said method further comprises:
after said first object has been removed from said cache, removing said hard unidirectional reference to said second object; and,
not removing said second object from said cache because of the existence of another hard reference to said second object.

53. The article of manufacture of claim 52 wherein said method further comprises said managing being performed within a software container that contains Java beans and said object oriented entity component is an entity bean.

54. The article of manufacture of claim 47 wherein said method further comprises said managing being performed within a software container that contains Java beans and said object oriented entity component is an entity bean.
